(19) United States
(12) Patent Application Publication
(10) Pub. No.: US 2017/0170855 A1
(43) Pub. Date: Jun. 15, 2017

(54) Top-hand Phone System

(71) Applicant: Walter Wilkins, JR., Hackensack, NJ (US)

(72) Inventor: Walter Wilkins, JR., Hackensack, NJ (US)

(21) Appl. No.: 14/967,303

(22) Filed: Dec. 12, 2015

(51) Int. Cl. H04B 1/3827; H04M 1/02; H04W 12/08

(52) U.S. Cl. CPC H04B 1/385; H04W 12/08; H04M 1/0206; H04M 1/0249; H04B 2001/3861

(57) ABSTRACT

A smartphone holder for preventing mobile communication loss and theft. A two bands wrist and finger combination connected by a rod connector with a mobile communication device attached atop.

### CROSS-REFERENCE TO RELATED APPLICATION

This application claims the benefit of U.S. Provisional Application No. 62/091,472, filed Dec. 12, 2014, No. 62/091,121, filed Dec. 12, 2014, No. 14/664,891, filed Mar. 22, 2015, the disclosures of which is incorporated herein by reference.

### STATEMENT REGARDING FEDERALLY SPONSORED RESEARCH OR DEVELOPMENT

[Not applicable]

### REFERENCE TO A SEQUENCE LISTING, A TABLE, OR A COMPUTER PROGRAM, LISTING COMPACT DISC APPENDIX (NOT APPLICABLE)

[Not applicable]

### BACKGROUND OF THE INVENTION

The subject invention provides improved security of mobile communication. This invention employs secure improvements over known devices in terms of loss and theft. Whereby direct contact with one's personage eliminate data loss incidents.

### BRIEF SUMMARY OF THE INVENTION

The present invention apparatus provides a secure method for attaching a mobile communication device to its wearer. Atop a base rod connecting to a wristband and finger band.

### BRIEF DESCRIPTION OF THE SEVERAL VIEWS OF THE DRAWING

For further understanding of the nature and objects of the present invention, reference should be made to the following drawing and descriptions.

FIG. 1 is a front view of the preferred embodiment of the invention. This configuration features the finger band 01, the rod connector 02; follow by the smartphone 03, and rod connector 02, with the wristband 04, in accordance with one or more implementations.

FIG. 2 is a perspective view of the preferred embodiment of the invention. The finger band with the hinge 05, pivot 06, in accordance with one or more implementations.

FIG. 4 is a top view of the preferred embodiment of the invention in accordance with one or more implementations.

### DETAILED DESCRIPTION OF THE INVENTION

The following describes embodiments of the present invention referring to the drawings.

### First Embodiment

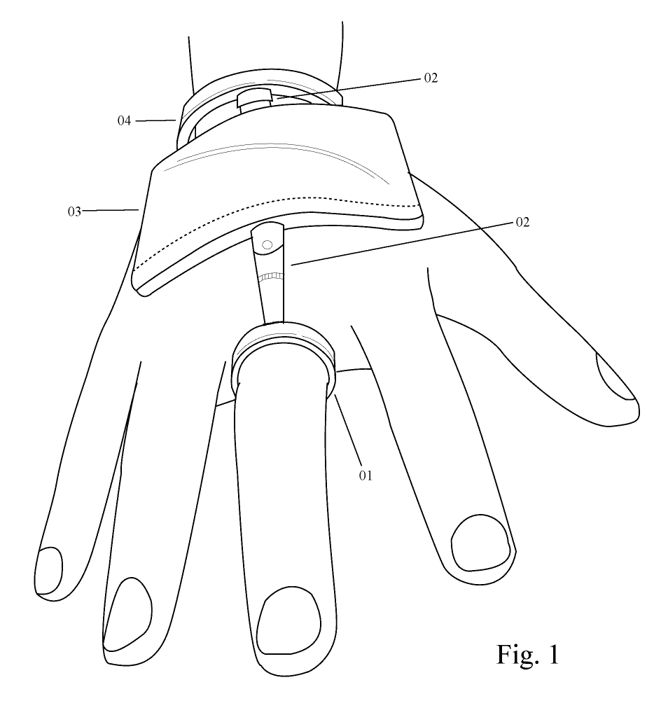

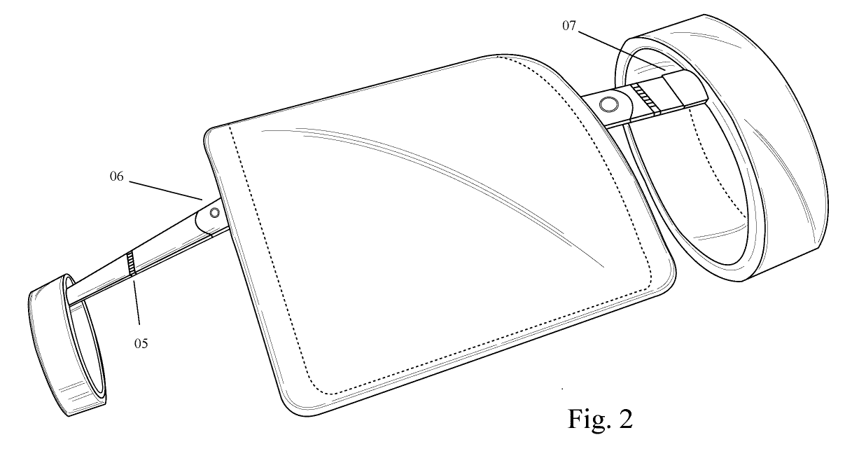

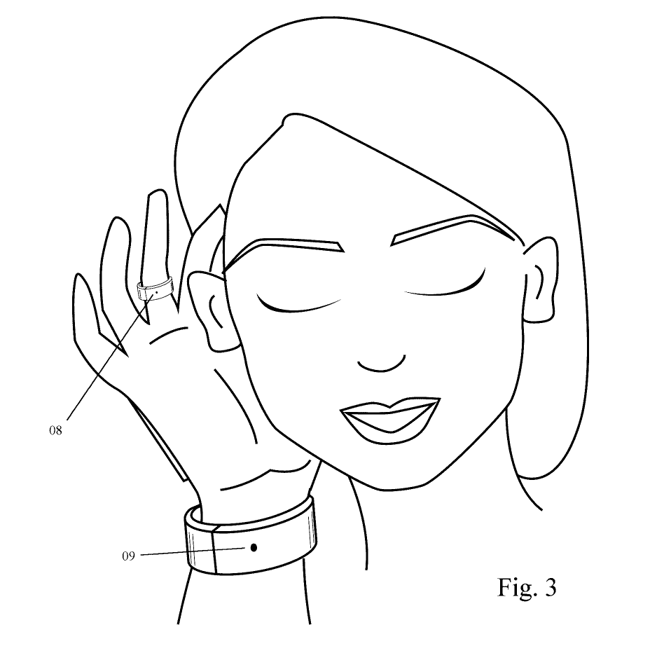

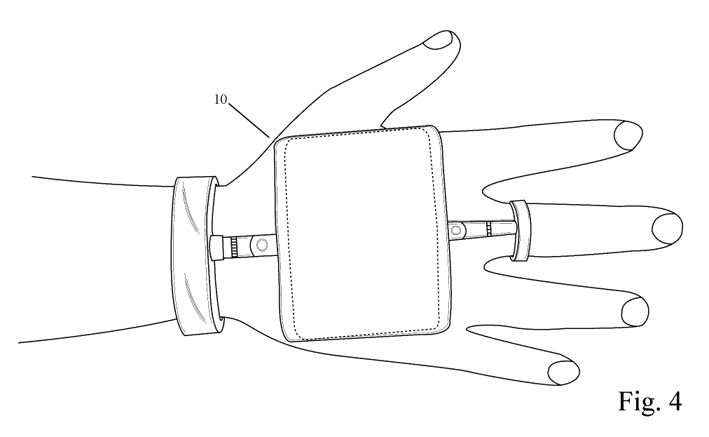

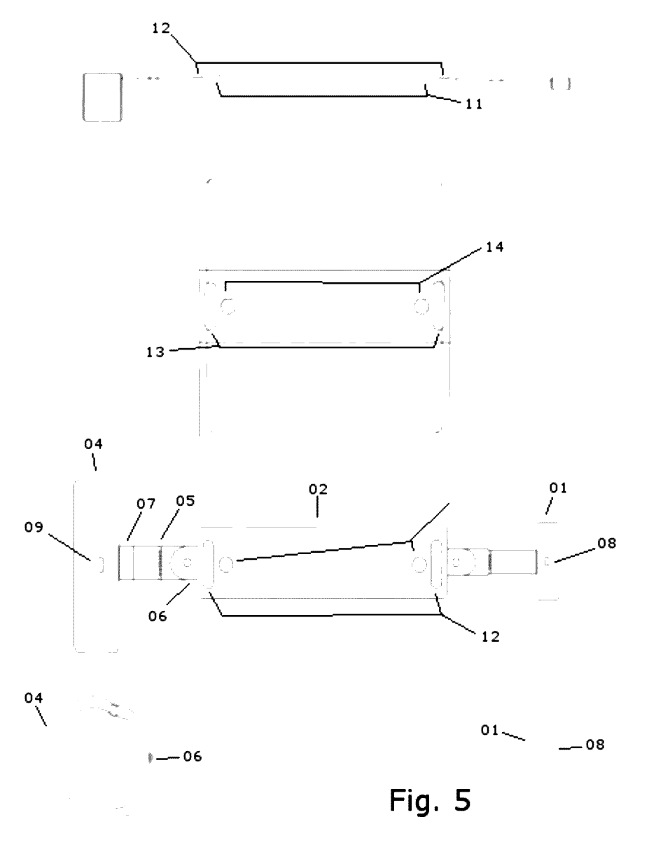

The smartphone holder defines a improved securing mechanism for wearable communication device. As in FIG. 1 illustrate front view of a person's hand with middle finger on finger band 01, and a connecting rod connector 02, with the affixed secured smartphone sitting on top rod connector 02, continuing into wristband 04.

1. A smartphone holder comprising:
a) a wristband;
b) and a finger band;
c) and a rod connector wherein sit a smartphone.

2-16. (canceled)
